(19) United States
(12) Patent Application Publication
(10) Pub. No.: US 2007/0267491 A1
(43) Pub. Date: Nov. 22, 2007

(54) Shop information distribution method, shop information distribution system, information management server and portable information terminal

(75) Inventors: Katsuya Muto, Tokyo (JP); Yasuhiro Hino, Tokyo (JP)

Correspondence Address: KRATZ, QUINTOS & HANSON, LLP, 1420 K Street, N.W., Suite 400, WASHINGTON, DC, 20005, US

(73) Assignee: AZ, LTD., Tokyo (JP)

(21) Appl. No.: 11/798,786

(22) Filed: May 16, 2007

(30) Foreign Application Priority Data
May 16, 2006 (JP) 2006-135971

(51) Int. Cl. G06K 15/00

(52) U.S. Cl. 235/383

(57) ABSTRACT

When a user requests distribution of event information of a shop from a mobile phone device, an information management server responds to the request and distributes the event information of the shop to the mobile phone device. When a user visits a shop and holds a mobile phone device with an IC tag attached thereto over a shop terminal, communication takes place between the IC tag and an IC tag reader-writer of the shop terminal, and the information management server acquires a shop ID thereof from the shop terminal, and distributes shop information concerning commodities and facilities of the shop to the mobile phone device. The information management server acquires customer/shop visit information, calculates the aggregate, and distributes the aggregate customer/shop visit information to a shop information server owned by an advertiser.

### CROSS-REFERENCE TO RELATED APPLICATION(S)

This application claims the foreign priority benefit under Title 35, United States Code, § 119 (a)-(d), of Japanese Patent Application No. 2006-135971, filed on May 16, 2006 in the Japan Patent Office, the disclosure of which is herein incorporated by reference in its entirety.

### BACKGROUND OF THE INVENTION

This invention relates to a shop information distribution method, a shop information distribution system, an information management server and a portable information terminal, for drawing customers to a shop or other facility.

Advertisements published on websites over the Internet have been attracting widespread attention as the third-generation advertising media. Advertisers of such advertisements over the Internet may draw members from Net-surfers for each subject of interest to the Net-surfers, so that the advertisers may distribute individual advertising information that suits the personal preferences or needs of each Net-surfer to the corresponding surfer individually. However, even the advertisements contrived as above could not ensure the effects specifically, as to how effectively the advertisements are expected to draw customers to a shop.

With this in view, a variety of approaches for improving the effectiveness of advertisements to draw customers conventionally have not only been proposed but also been put into practice. For example, JP 2003-216860 A discloses an information distribution system in which discount coupons of goods are distributed together with relevant advertising information, value-adding information on goods (e.g., information associated with bargain-priced food ingredients, as to a recipe for making an item of food from the ingredients) is distributed, to thereby improve the effectiveness of advertisements to draw customers. JP 2005-326942 A discloses another information distribution system in which encrypted data of an article of a magazine, a piece of music, an amusement ticket usable at a shop are distributed from a shop having an amusement facility to portable information terminals such as mobile phone devices of members, and key data for decrypting the encrypted data are distributed at a terminal in the shop, to thereby effectively enhance the members' willingness to visit the shop.

On the other hand, as means for facilitating authentication of members and provision of shop coupons, shop information, and the like, membership cards each having an IC (integrated circuit) tag embedded therein (e.g., FeliCa®, Suica®, etc.) and mobile phone devices each having a similar IC tag embedded therein are coming into widespread use. As a system for such mobile phone devices, in which not only are shop coupons or shop information provided, but also means for exchanging the coupons among members are provided, ToruCa® is available for practical use. For ToruCa, see the website published by NTT DoCoMo, Inc. on the Internet at <URL: http://www.nttdocomo.co.jp/service/imode/osaifu/toruca/index.html> (retrieved on Mar. 3, 2006) (Corresponding English page is available, see <URL: http://www.nttdocomo.co.jp/english/service/imode/osaifu/toruca.html>).

In the information distribution systems as disclosed in JP 2003-216860 A and JP 2005-326942 A, however, the advertising information including discount coupons and value-adding information is configured to be distributed to all the members at any time. That is, the advertising information may be distributed to a member at a date or a period when the member does not necessarily wish to receive the information. Accordingly, the effectiveness of the advertising information is impaired on this account.

Moreover, in these information distribution systems, advertising information which a system distributes for an advertiser having a chain of franchise shops or the like may inevitably be limited to information that is common to all the franchise shops. This is because the increased quantity of information which would have to be distributed when specific information such as an original event or bargain information of each shop were provided would place the mobile phone devices or other portable information terminals at a particular disadvantage in their limited amount of displayable information and in their communication costs.

Furthermore, in a system such as ToruCa®, shop information specific to a shop may be provided through a shop terminal of the shop; however, advertising information distributed through the Internet and shop information provided through the shop terminal are not associated with each other. Therefore, the advertising effectiveness of specific advertising information distributed through the Internet cannot be evaluated, on the basis of the number of accesses to the shop information through the shop terminal, or other information.

The present invention has been made in view of the above-discussed disadvantages involved in the conventional arts.

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

### SUMMARY OF THE INVENTION

In one aspect of the present invention, there is provided a shop information distribution method, a shop information distribution system, an information management server, and a portable information terminal, whereby advertising information can be distributed efficiently to a user who wishes to receive the advertising information so as to draw customers to a shop effectively, detailed advertising information specific to a shop can be distributed to a user who has visited the shop at the request of the user, and information indicative of the effectiveness of the distributed advertising information in drawing customers can be obtained.

To be more specific, in one exemplary embodiment of the present invention, a shop information distribution system is provided which comprises an information management server, a portable information terminal and a shop terminal, wherein the information management server comprises an event information storage unit configured to store event information (which may be classified into predetermined categories, for example) for shops, and a shop information storage unit configured to store shop information on merchandise and equipment of the shops, wherein the portable information terminal comprises a display unit, and wherein the shop terminal is installed in each shop. In this shop information distribution system, (1) the portable information terminal is configured to send an event information distribution request for requesting distribution of event information (with a category specified, for example); (2) the information management server is configured to, upon receipt of the event information distribution request, retrieve event information belonging to the category specified therein, from the event information storage unit, and distribute the retrieved event information to the portable information terminal; (3) the portable information terminal is configured to receive the distributed event information, and show the received event information on the display unit; (4) the portable information terminal is configured to retrieve, from the shop terminal, identifying information of the shop terminal, and send a shop information distribution request for requesting distribution of shop information of the shop in which the shop terminal is installed, with the retrieved identifying information of the shop terminal attached thereto, to the information management server; (5) the information management server is configured to, upon receipt of the shop information distribution request, retrieve the shop information of the shop from the shop information storage unit, and distribute the retrieved shop information to the portable information terminal; and (6) the portable information terminal is configured to receive the distributed shop information, and show the received shop information on the display unit.

### BRIEF DESCRIPTION OF THE DRAWINGS

The above aspects and advantages, and other advantages and further features of the present invention will become more apparent by describing in detail illustrative, non-limiting embodiments thereof with reference to the accompanying drawings, in which:

FIG. 1 is a diagram showing an example of general block configuration of a shop information distribution system according to a first embodiment of the present invention;

FIG. 2 is a diagram showing an example of block configuration of a mobile phone device according to the first embodiment of the present invention;

FIG. 3 is a diagram showing an example of internal configuration of an IC tag embedded in the mobile phone device according to the first embodiment of the present invention;

FIG. 4 is a diagram showing an example of functional block configuration of the shop information distribution system according to the first embodiment of the present invention;

FIG. 5 is a diagram showing an example of structures of information for use in the shop information distribution system according to the first embodiment of the present invention;

FIG. 6 is a diagram showing an example of a flow of a user application distribution process for distributing a user application from an information management server to a mobile phone device according to the first embodiment of the present invention;

FIG. 7 is a diagram showing an example of a display screen shown on a display of the mobile phone device in the user application distribution process according to the first embodiment of the present invention;

FIG. 8 is a diagram showing an example of a flow of an event information distribution process for distributing event information from an information management server to a mobile phone device according to the first embodiment of the present invention;

FIG. 9 is a diagram showing an example of a display screen shown on a display of the mobile phone device in the event information distribution process according to the first embodiment of the present invention;

FIG. 10 is a diagram showing an example of a flow of a shop information distribution process for distributing shop information from an information management server to a mobile phone device according to the first embodiment of the present invention;

FIG. 11 is a diagram showing an example of functional block configuration of the shop information distribution system according to a second embodiment of the present invention; and

FIG. 12 is a diagram showing an example of functional block configuration of the shop information distribution system according to a third embodiment of the present invention.

### DETAILED DESCRIPTION OF THE EXEMPLARY EMBODIMENTS

A detailed description will be given hereinbelow of embodiments of the present invention with reference to the drawings.

### First Embodiment

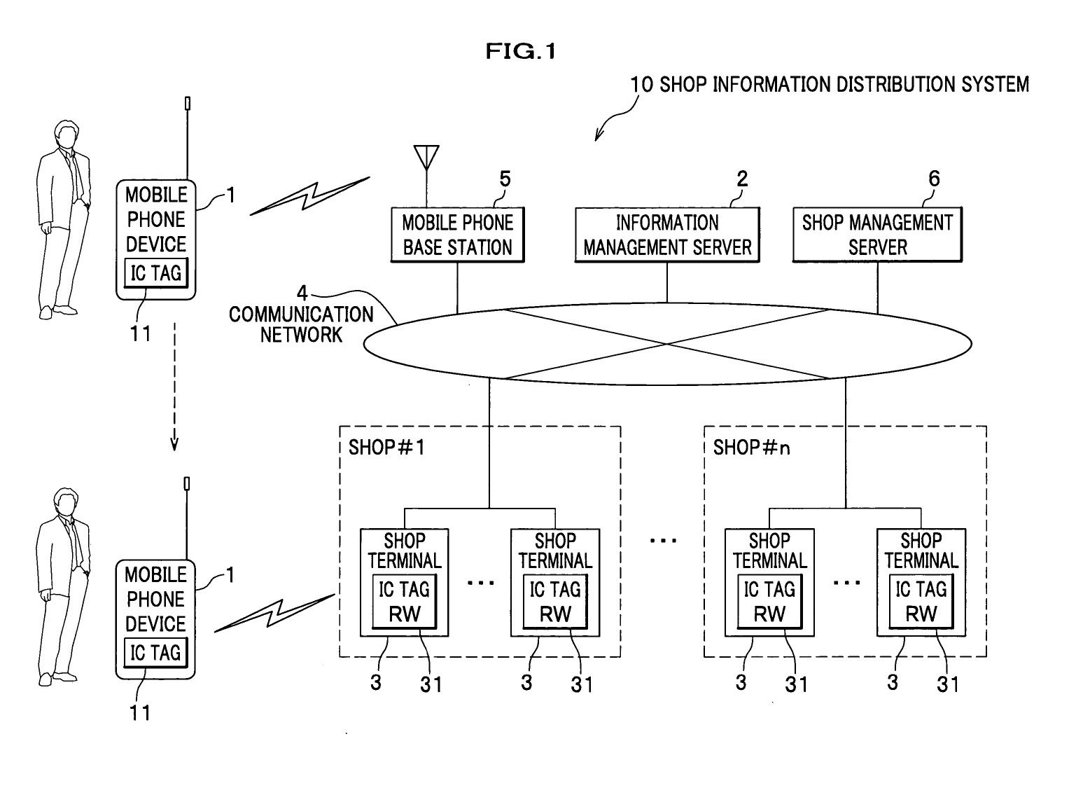

FIG. 1 is a diagram showing an example of general block configuration of a shop information distribution system according to a first embodiment of the present invention.

As shown in FIG. 1, a shop information distribution system 10 includes a mobile phone device 1 to be carried by a user, an information management server 2 configured to manage information such as advertising information to be distributed to the mobile phone device 1 of the user, a shop terminal 3 installed in a shop and capable of short-range weak-radio-wave data communication with the mobile phone device 1, a shop management server 6 owned by an advertiser, and other components.

The mobile phone device 1 and the information management server 2 are coupled with each other through a communication network 4 which includes a mobile phone base station 5, a mobile phone network, the Internet, etc. The shop management server 6, the shop terminal 3 and the information management server 2 are also coupled with one another through the same communication network 4.

The mobile phone device 1 includes an IC tag 11, and the shop terminal 3 includes an IC tag reader/writer (hereinafter referred to in abbreviated form as “IC tag RW”) 31. Each of the IC tag 11 and the IC tag RW 31 includes a short-range wireless communication device for performing a wireless communication, for example, within a range of 10 cm or so. Accordingly, when the mobile phone device 1 is held over a portion of the shop terminal 3 near a position where the IC tag RW 31 is installed, data communication with a predetermined weak radio wave according to a predetermined protocol takes place between the IC tag 11 and the IC tag RW 31.

Specifications of the IC tag 11 used in this operation may be the same as those of FeliCa® as described above, or may be of another type of IC tag having similar functionality and construction.

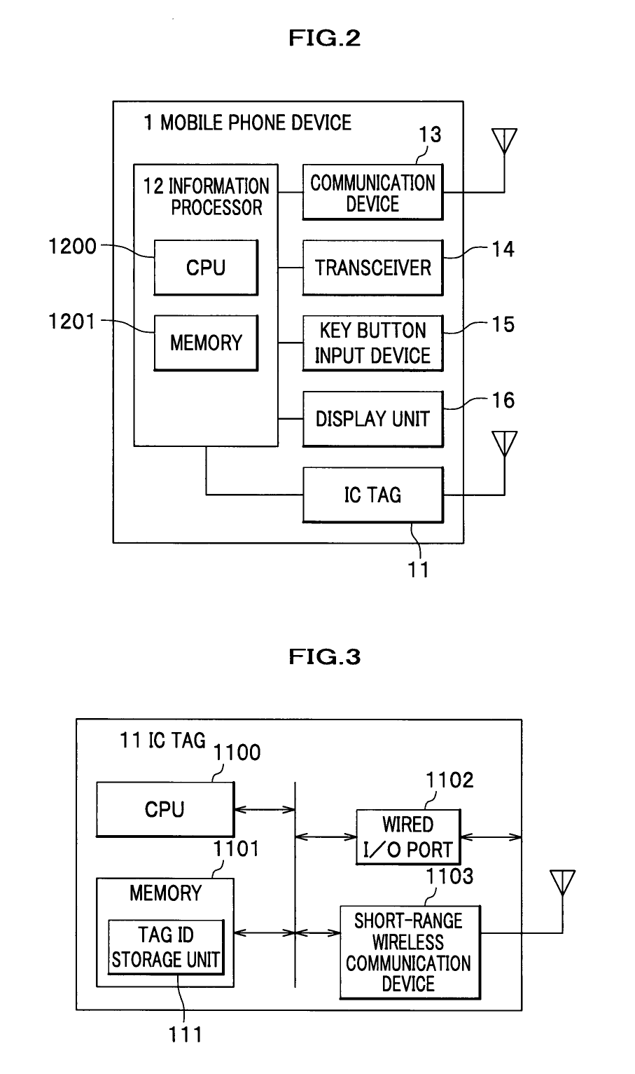

FIG. 2 is a diagram showing an example of block configuration of a mobile phone device according to the first embodiment of the present invention, and FIG. 3 is a diagram showing an example of internal configuration of an IC tag embedded in the mobile phone device.

As shown in FIG. 2, the mobile phone device 1 includes: an information processor 12 having a CPU (Central Processing Unit) 1200, a memory 1201 and the like; and components coupled therewith, wherein the components include a communication device 13 for communicating with a mobile phone base station 5, a transceiver 14 for interconversion between an electric signal and an audio signal, a key button input device 15 for allowing an operator to input data, a display unit 16 including an LCD (Liquid Crystal Display) and/or the like; and an IC tag 11. Hereupon, the CPU 1200 is configured to execute a predetermined program stored in the memory 1201 composed of an electrically programmable nonvolatile memory such as a flash memory, so as to control the communication device 13, the transceiver 14, the key button input device 15, the display unit 16, etc. where appropriate, thereby achieving predetermined functions of the mobile phone device 1.

As shown in FIG. 3, the IC tag 11 includes: a CPU 1100, a memory 1101 composed of an electrically programmable nonvolatile memory such as a flash memory; an I/O port 1102 for establishing wired connection to the outside; and a short-range wireless communication device 1103. A predetermined area of the memory 1101 is allocated to a tag ID storage unit 111 for storing a tag ID by which each IC tag 11 is uniquely identifiable.

The tag ID is information for identifying the mobile phone device 1 or a user thereof, and is always transmitted from the mobile phone device 1 to the shop terminal 3 when data communication takes place between the IC tag 11 and the IC tag RW 31. The information processor 12 of the mobile phone device 1 is configured to be able to retrieve a tag ID stored in the tag ID storage unit 111 through the wired I/O port 1102.

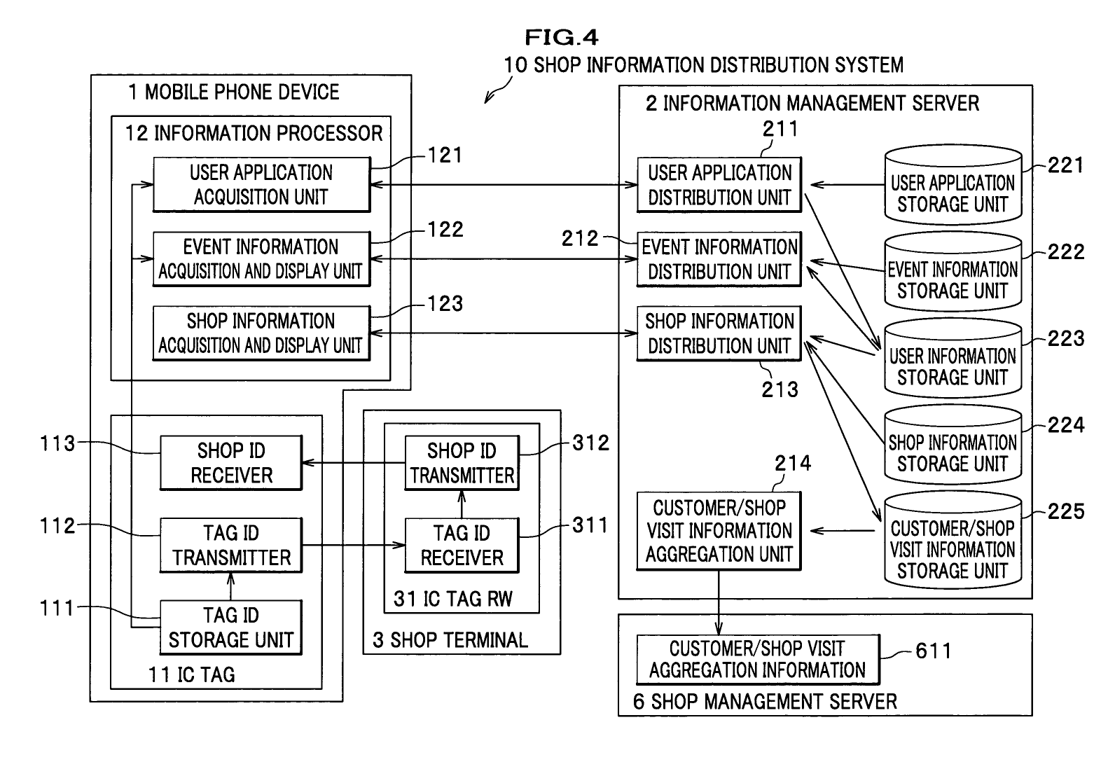

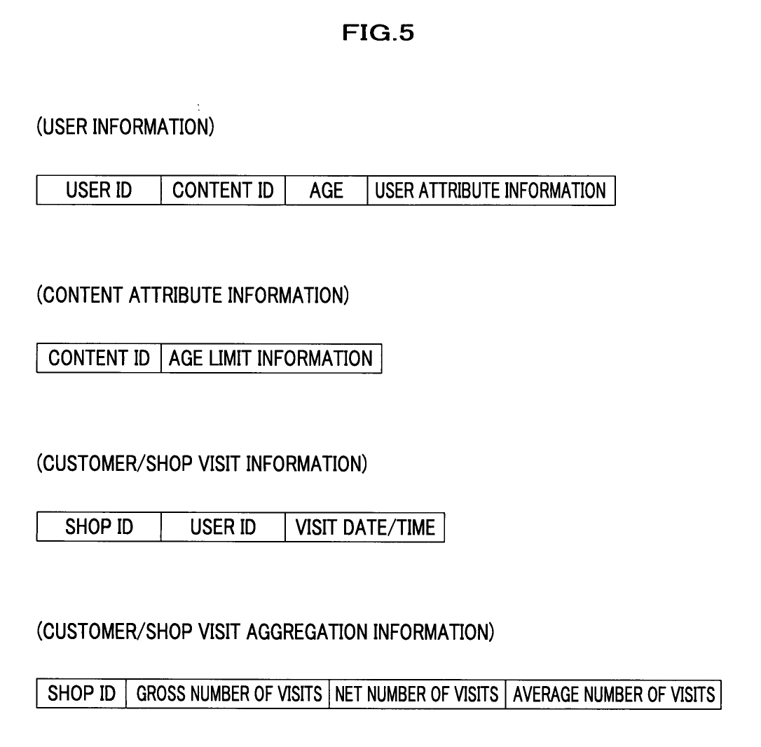

FIG. 4 is a diagram showing an example of functional block configuration of the shop information distribution system according to the first embodiment of the present invention. FIG. 5 is a diagram showing an example of structures of information for use in the shop information distribution system.

As shown in FIG. 4, the mobile phone device 1 has functional blocks, such as a user application acquisition unit 121, an event information acquisition and display unit 122, a shop information acquisition and display unit 123, and others, deployed on the information processor 12. To be more specific, functions of these functional blocks are achieved by the CPU 1200 (see FIG. 2) of the information processor 12 executing predetermined programs stored in the memory 1201. Specific functions of these functional blocks will be described later.

On the other hand, the IC tag 11 includes, other than the tag ID storage unit 111 as described above, a tag ID transmitter 112 and a shop ID receiver 113. Furthermore, the IC tag RW 31 of the shop terminal 3 includes a tag ID receiver 311 and a shop ID transmitter 312.

When a user holds the mobile phone device 1 over a portion of the shop terminal 3 near the position where it is installed, short-range data communication with a predetermined weak radio wave takes place between the IC tag 11 and the IC tag RW 31. Thus, during the data communication, a tag ID stored in the tag ID storage unit 111 is transmitted by the tag ID transmitter 112 to the IC tag RW 31. The transmitted tag ID is received by the tag ID receiver 311 of the IC tag RW 31, and upon receipt thereof, the shop ID transmitter 312 transmits a shop ID assigned to the shop terminal 3 to the IC tag 11. Then the shop ID receiver 113 of the IC tag 11 receives the transmitted shop ID, and inputs the shop ID into the information processor 12.

As shown in FIG. 4, the information management server 2 includes a function execution section and an information storage section, wherein the function execution section includes a user application distribution unit 211, an event information distribution unit 212, a shop information distribution unit 213, and a customer/shop visit information aggregation unit 214, and wherein the information storage section includes a user application storage unit 221, an event information storage unit 222, a user information storage unit 223, a shop information storage unit 224, and a customer/shop visit information storage unit 225. The information management server 2 includes, though not shown specifically in the drawing, a CPU as an information processor, a memory as a main memory, a hard disk drive as an auxiliary storage, and other components. The functions of the function execution section are achieved by the information processor executing predetermined programs loaded in the memory. The information storage section is implemented typically as predetermined storage areas allocated thereto in the hard disk drive.

Specific functions of the function execution section will be described later, together with the specific functions of the functional blocks of the information processor 12 of the mobile phone device 1.

Referring now to FIG. 5, a description will be given of structures of various types of information for use in the present embodiment.

User information is information concerning a user of the mobile phone device 1 to which the information management server 2 distributes contents, and includes the fields of USER ID, CONTENT ID, AGE, and USER ATTRIBUTE INFORMATION. The user information is created, and stored in the user information storage unit 223, when the information management server 2 receives a request for distribution of contents from the mobile phone device 1, as will be described later.

The USER ID includes information by which a user is identifiable, and it is assumed in this embodiment that a tag ID assigned to the IC tag 11 of the mobile phone device 1 is used for the USER ID. Alternatively, identifying information assigned to the mobile phone device 1, instead of the tag ID, may be used for the USER ID.

The CONTENT ID includes information by which a content of shop information a user desires to receive is identifiable. For example, in a case where the shop information distribution system 10 holds information on a specific chain of pachinko parlors, information on a specific chain of hotels, and information on spas in a specific area, each piece of information is provided under a different category of contents, and the CONTENT ID is employed as information for identifying the category of each content.

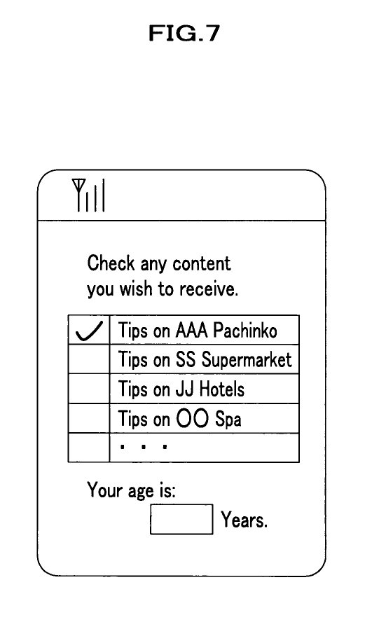

The AGE represents the age of a user, and is used for the purpose of controlling distribution of the contents which are restricted to users of legal age. For example, distribution of information on chains of pachinko parlors to users under the age of 18 may be prohibited, and distribution of information on liquor shops to users under the age of 20 may be prohibited. The information in the AGE is not necessarily represented by years of age, but may be represented by age brackets or by dates of birth. The AGE may be acquired for example through a screen (see FIG. 7 which will be explained later) for queries to a user about contents the user wishes to obtain, or the like. Depending upon the contents the user wishes to obtain, the AGE may not be acquired and thus the AGE field may be left blank.

The USER ATTRIBUTE INFORMATION includes information on various user attributes such as a sex, an address, etc., and is used if necessary or convenient depending upon the contents. In most cases, this field may be left blank.

Content attribute information is created for each CONTENT ID, and includes the fields of CONTENT ID and AGE LIMIT INFORMATION. The AGE LIMIT INFORMATION includes information on legal age associated with the content specified by the CONTENT ID, and may include an age defining the limit or a flag indicating the limit-defining age. The flag indicating the limit-defining age may be defined for example as follows: no set age limit is indicated by ‘0’; age limit set under 18 is indicated by ‘1’; and age limit set under 20 is indicated by ‘2’.

In the foregoing discussion, the content(s) refers to information to be distributed by the information management server 2 to the mobile phone device 1, and to be more specific, includes information stored in the event information storage unit 222 and the shop information storage unit 224, as well as information linked therewith, which may be stored in other storage areas of the server or storage areas in other computers. The same goes for the following discussion in this specification.

In FIG. 5, customer/shop visit information includes the fields of SHOP ID, USER ID, and VISIT DATE/TIME, and is stored in the customer/shop visit information storage unit 225. The SHOP ID includes information by which a shop is uniquely identifiable, and in the present embodiment, is set in the shop terminal 3 or the IC tag RW 31, for example. The customer/shop visit information is created when a user carrying a mobile phone device 1 visits a shop, holds the mobile phone device 1 over a shop terminal 3 therein, and causes a short-range data communication to take place between the mobile phone device 1 and the shop terminal 3.

Customer/shop visit aggregation information is information resulting from aggregation of the customer/shop visit information for each shop within each period of time having a predetermined duration (e.g., one day, one week, one month, etc.). In this embodiment, the customer/shop visit aggregation information includes SHOP ID, GROSS NUMBER OF VISITS, NET NUMBER OF VISITS, AVERAGE NUMBER OF VISITS, and other fields of information. The customer/shop visit aggregation information is created by the customer/shop visit information aggregation unit 214. The created customer/shop visit aggregation information is transmitted to the shop management server 6 owned by an advertiser, and stored as customer/shop visit aggregation information 611 in the shop management server 6.

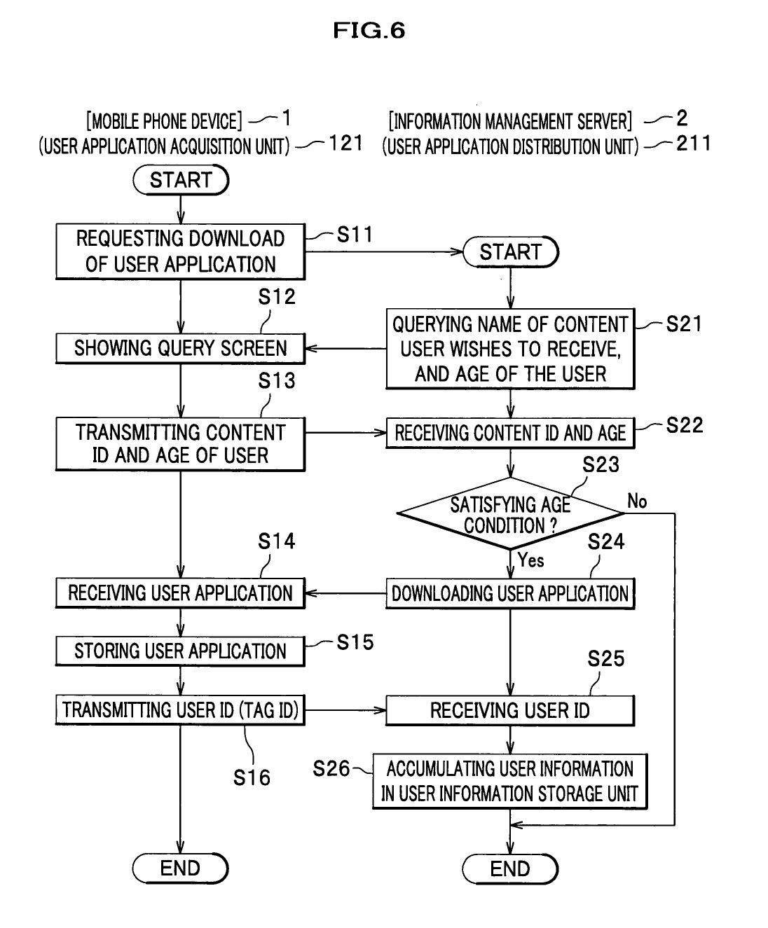

FIG. 6 is a diagram showing an example of a flow of a user application distribution process for distributing a user application from an information management server to a mobile phone device according to the first embodiment of the present invention. FIG. 7 is a diagram showing an example of a display screen shown on a display of the mobile phone device in the user application distribution process. The user application distribution process flow will be described hereinbelow with reference to FIGS. 6, 7 and 4.

In FIGS. 4 and 6, the user application refers to an application program for the mobile phone device 1 which is to be distributed from the information management server 2 to the mobile phone device 1, and to be more specific, includes programs for achieving the functions of the event information acquisition and display unit 122 and the shop information acquisition and display unit 123 in the mobile phone device 1. The user application may also include programs for other applications such as a game, a fortune-telling, a calendar, etc. The user application is stored in the user application storage unit 221.

In the present embodiment, a user who wishes to receive a distributed content operates his/her mobile phone device 1 to start the user application acquisition unit 121, and then the information processor 12 of the mobile phone device 1 (the subject of operation will be hereinafter referred to “mobile phone device 1” for simplicity) makes a request to the information management server 2 for download of the user application (step S11) at the outset. This process can be achieved by a web browser with which the mobile phone device 1 typically comes equipped as standard equipment.

The process of the user application distribution unit 211 of the information management server 2 is started when the information processor (not shown in FIG. 4) of the information management server 2 receives the request for download of the user application sent from the mobile phone device 1. The information processor of the information management server 2 (the subject of operation will be hereinafter referred to “information management server 2” for simplicity) transmits query information for the name of a content user wishes to receive, the age of the user, and the like, to the mobile phone device 1 (step S21).

Upon receipt of the query information, the mobile phone device 1 shows a query screen therefor formulated in accordance with the query information on the display unit 16 (step S12). As shown in FIG. 7, the names of the contents and other information are shown in the query screen so that the user can choose a content he/she wishes to receive, by check-marking an appropriate check box. The age of the user may be input where necessary.

When the user chooses a content he/she wishes to receive, and/or inputs his/her age, the mobile phone device 1 transmits, to the information management server 2, information which includes the content ID of the chosen content and/or the age of the user, etc. (step S13).

Next, the information management server 2 receives the information which includes the content ID and/or the age of the user, etc. (step S22), and consults the content attribute information to check whether or not the content has any set age limit, and determines whether or not the age of the user satisfies the age condition (step S23). If it turns out as a result of the determination that the age condition is satisfied (Yes in step S23), then the information management server 2 allows a predetermined user application stored in the user application storage unit 221 to be downloaded to the mobile phone device 1 (step S24).

The mobile phone device 1 receives the downloaded user application (step S14), and stores the received user application in the memory 1201 of the information processor 12 (step S15). The mobile phone device 1 retrieves the tag ID from the tag ID storage unit 111, and transmits the retrieved tag ID, as a user ID, to the information management server 2 (step S16).

Next, the information management server 2 receives the user ID (step S25), and creates user information by combining the content ID of the content the user wishes to receive and the age of the user which have previously been received, with the user ID, to accumulate the user information in the user information storage unit 223 (step S26). In the present embodiment, the accumulation of the user information in the user information storage unit 223 is equivalent to what is called registration of user information. If it turns out as a result of the determination in step S23 that the age of the user fails to fulfill the age condition (No in step S23), then no user application is downloaded, and the registration of user information is not carried out either. In this instance, a warning message to the effect that the user is under the statutory age limit may be transmitted to the mobile phone device 1 so that the warning message is shown on the display unit 16 thereof.

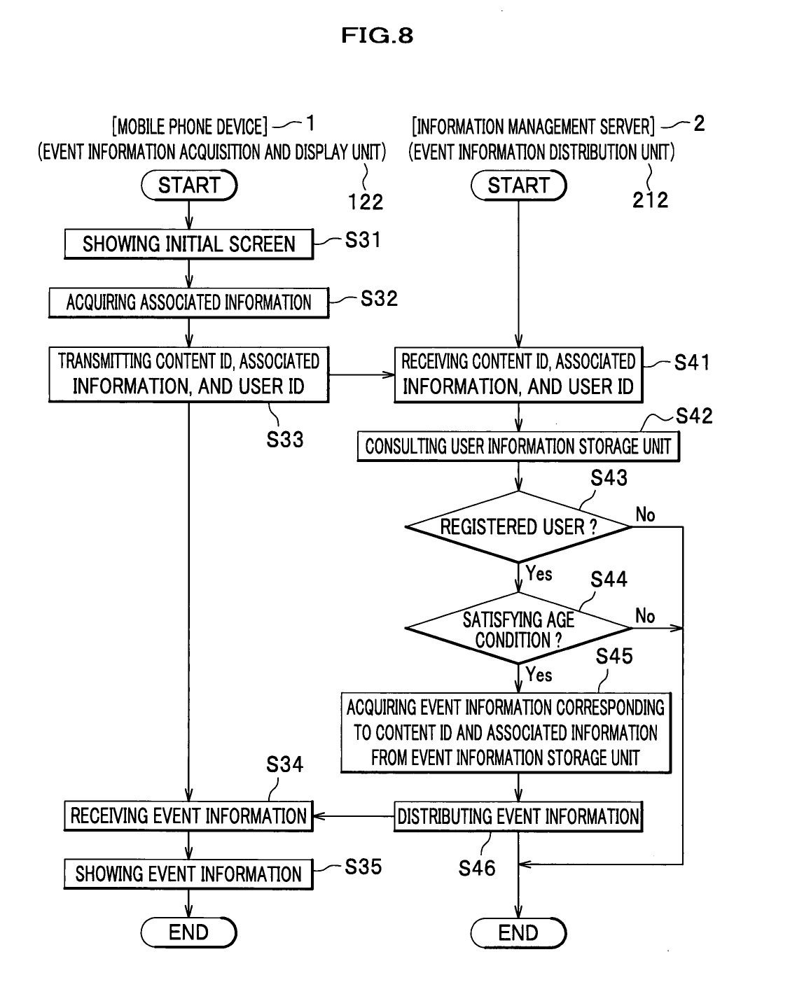

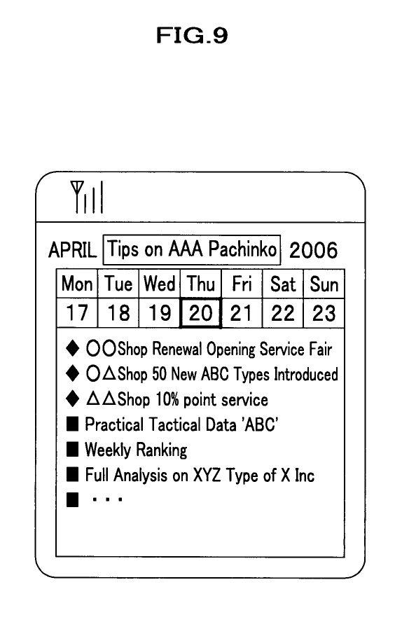

FIG. 8 is a diagram showing an example of a flow of an event information distribution process for distributing event information from an information management server to a mobile phone device according to the first embodiment of the present invention. FIG. 9 is a diagram showing an example of a display screen shown on a display of the mobile phone device in the event information distribution process. The event information distribution process flow will be described hereinbelow with reference to FIGS. 8, 9 and 4.

Herein, it is appreciated that the event information refers to pieces of information collected on shops or facilities belonging to a specific category and arranged mainly as information representing special events or topics of the shops or facilities. In some instances, the event information storage unit 222 may be placed in a storage area for web pages established in a web server, so that advertisers may easily write event information therein for example through the shop management server 6.

In general, advertising information such as event information is transmitted from the information management server 2 to the mobile phone device 1 in the form of e-mail or the like in most instances; in the present embodiment, however, when a user wishes, a request for event information is transmitted from the mobile phone device 1, and the information management server 2 distributes relevant event information in response to the request. Accordingly, in order to acquire event information, the user operates the mobile phone device 1 and starts the process in the event information acquisition and display unit 122.

When the process in the event information acquisition and display unit 122 is started, the mobile phone device 1 first shows a predetermined initial screen on the display unit 16 thereof (step S31). At this stage, the display screen shows a calendar, an area map or the like, for example; thus, the user may choose a date and/or an area in which shops are located, etc. to check when and where a specific event is scheduled. Then, the mobile phone device 1 acquires information associated with the date and/or the area (step S32), and transmits the content ID of the content the user has registered as a content to be distributed, the acquired associated information, and the user ID, to the information management server 2 (step S33), so as to request distribution of the event information.

The information management server 2 receives the transmitted content ID, associated information and user ID (step S41), consults the user information storage unit 223 based upon the user ID (step S42) to check whether or not the user ID is of a registered user (step S43), and consults the age limit information of the content attribute information to check whether or not the user fulfills the age condition of the content (step S44).

If the results of these checking steps show that the user who has requested distribution of the event information is a registered user and fulfills the age condition (Yes in both steps S43 and S44), then the information management server 2 acquires relevant event information corresponding to the specified content ID and associated information, from the event information storage unit 222 (step S45), and distributes the acquired event information to the mobile phone device 1 (step S46).

The mobile phone device 1 receives the distributed event information (step S34), and shows the received event information on the display unit 16 as shown in the display sample of FIG. 9 (step S35).

If the results of the checking steps show that the user who has requested distribution of the event information is not a registered user (No in step S43) or fails to fulfill the age condition (No in step S44), then the mobile phone device 1 distributes no event information. In this instance, a warning message to the effect that the user is not registered or that the user is under the statutory age limit may be transmitted to the mobile phone device 1 so that the warning message is shown on the display unit 16 thereof.

As shown in the example of FIG. 9, the event information may include not only event information of a shop but also general information of the same category as that of the shop information. For example, if the shop information relates to a chain of pachinko parlors, the event information may include information such as methods for getting through popular types of pachinko machines, or tactical data therefor, which would otherwise appear exclusively in magazines or the like. Alternatively, contrariwise, such general information as would otherwise appear in magazines of a specific category may incorporate event information of a shop.

In FIG. 9, each item of the event information or general information is shown in one line or so, but further detailed information may be hyperlinked from the line. In this instance, when the user selects and clicks on the line, the mobile phone device 1 retrieves detailed information from a hyperlinked site, and shows the detailed information therein.

This makes the event information distributed to the user more attractive to the user, and thus encourages the user to request event information more frequently. The effectiveness of advertisement of the event information of the shop is improved accordingly.

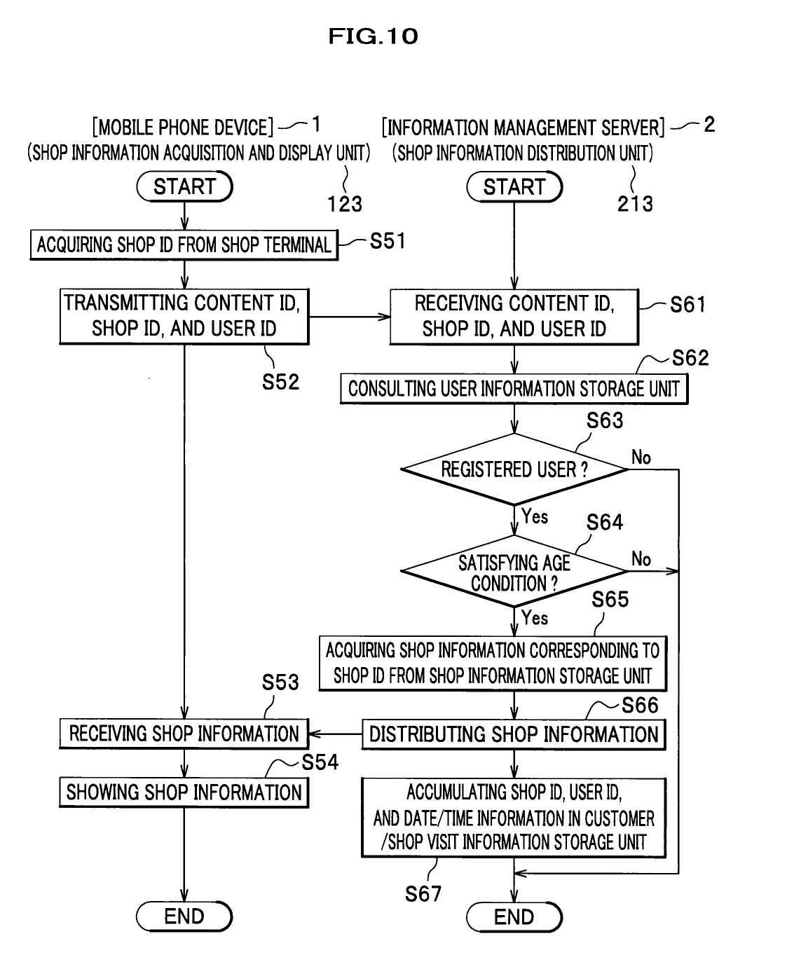

FIG. 10 is a diagram showing an example of a flow of a shop information distribution process for distributing shop information from an information management server to a mobile phone device according to the first embodiment of the present invention. The event information distribution process flow will be described hereinbelow with reference to FIGS. 10 and 4.

Herein, the shop information is information relating to commodities (merchandise), facilities (equipment) and services in a specified shop, and particularly to information which benefits users. For example, if the shop is a pachinko parlor, the shop information may includes in-shop jackpot possibility information, etc., and if the shop is a supermarket, the day's special bargain information, etc. The shop information as above is distributed from the information management server 2 to the mobile phone device 1 when a user goes to the shop and causes data communication to take place in actuality between the mobile phone device 1 the user carries and the shop terminal 3.

When a user holds his/her mobile phone device 1 over a predetermined position on the shop terminal 3, predetermined data communication takes place between the IC tag 11 of the mobile phone device 1 and the IC tag RW 31 of the shop terminal 3, and thereby a process in the shop information acquisition and display unit 123 of the mobile phone device 1 is started. To be more specific, through the communication, first, the mobile phone device 1 acquires a shop ID from the shop terminal 3 (step S51). Then, the mobile phone device 1 transmits a content ID of the content the user has registered as a content to be distributed, the acquired shop ID, and a user ID, to the information management server 2 (step S52), to request distribution of the shop information.

The information management server 2 receives the transmitted content ID, shop ID and user ID (step S61), consults the user information storage unit 223 based upon the user ID (step S62) to check whether or not the user ID is of a registered user (step S63), and consults the age limit information of the content attribute information to check whether or not the user fulfills the age condition of the content (step S64).

If the results of these checking steps show that the user who has requested distribution of the shop information is a registered user and fulfills the age condition (Yes in both steps S63 and S64), then the information management server 2 acquires relevant shop information corresponding to the specified content ID from the shop information storage unit 224 (step S65), and distributes the acquired shop information to the mobile phone device 1 (step S66). Furthermore, the information management server 2 creates customer/shop visit information by attaching date information of the day to the shop ID and user ID which have been acquired, and accumulates the customer/shop visit information in the customer/shop visit information storage unit 225 (step S67).

If the results of the checking steps show that the user who has requested distribution of the shop information is not a registered user (No in step S63), or fails to fulfill the age condition (No in step S64), then the mobile phone device 1 distributes no shop information, and creates no customer/shop visit information. In this instance, a warning message to the effect that the user is not registered or that the user is under the statutory age limit may be transmitted to the mobile phone device 1 so that the warning message is shown on the display unit 16 thereof.

On the other hand, the mobile phone device 1 receives the distributed shop information (step S53), and shows the received shop information on the display unit 16 (step S54). In this way, the user can acquire ‘beneficial’ shop information specifically for the user.

From the foregoing, according to the first embodiment of the present invention, when the user of the mobile phone device 1 submits an entry for requesting registration of distribution of contents with a category specified thereto to the information management server 2, an application program (user application) of the mobile phone device 1 for acquiring and displaying information on shops related to the contents is distributed from the information management server 2. The user may cause the mobile phone device 1 to execute the user application, and by doing so, can acquire event information of the shops of his/her registered category and general information related to the category, at any time in a simple operation. In this situation, it can be understood that the user has much interest in the category, and that the user voluntarily acquires advertising information; therefore, the effectiveness of advertisement presented to such a user can be highly evaluated.

When a user visits a shop for such a reason or others that the user has seen event information of the shop, and holds his/her mobile phone device 1 in the vicinity of a position on the shop terminal 3 where the IC tag RW 31 is installed, the mobile phone device 1 shows bargain information, etc. applied particularly to the shop. As a result, the user can acquire ‘beneficial’ information of the shop. On the other hand, the information management server 2 can acquire information on the incident that the user visits the shop, and information on the aggregated number of the visits. The information on the aggregated number of visits of the user to the shop is provided to the advertiser.

Accordingly, in the present embodiment, the advertiser can not only gain a high degree of advertising effectiveness which enhances efficiency of drawing customers, but also acquire information concerting the activities of the customers such as information on their visits to the shop.

In the shop information distribution system 10 as described above, it may become established that the advertiser pays fees for distribution of advertising information (event information and shop information), for example, in accordance with the gross number of customers visiting the shop as aggregated by the customer/shop visit information aggregation unit 214. In this instance, the advertiser pays advertising fees proportional to the effectiveness of advertisements to draw customers; therefore, this method of determining the advertising fees can be considered to be fairly reasonable. On the other hand, information distribution to users may be rendered free of charge, so that increase in the number of registered users, i.e., those who see the advertisements, can be expected.

### Second Embodiment

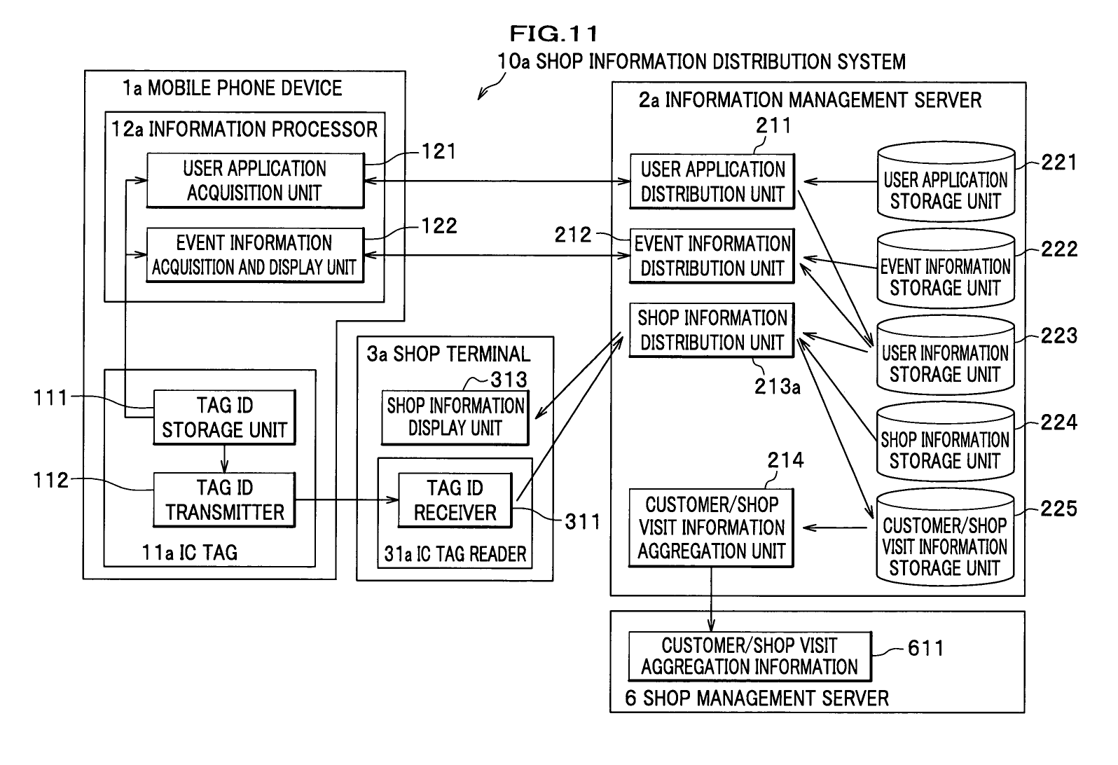

FIG. 11 is a diagram showing an example of functional block configuration of the shop information distribution system according to a second embodiment of the present invention.

The shop information distribution system 10a according to the second embodiment and the shop information distribution system 10 (see FIG. 4) according to the first embodiment are substantially the same in their principal functions and general configurations, and only partially different from each other in detailed functions and configurations. Herein, the same components are designated by the same reference numerals, and a duplicate description thereof will be omitted, whereas the configuration and functions of only the different portion will be described.

Functional difference lies in one point as follows. When a user holds his/her mobile phone device 1 over a shop terminal 3, the information management server 2 in the first embodiment is configured to distribute shop information to the mobile phone device 1 of the user, but the information management server 2a in the second embodiment is configured to distribute the shop information not to the mobile phone device 1a of the user but to the shop terminal 3a, so that the shop terminal 3a shows the distributed shop information on a display unit (not shown).

To achieve this functionality, the shop terminal 3a includes a shop information display unit 313. Furthermore, the shop terminal 3a need not transmit the shop ID to the mobile phone device 1a, and thus does not necessarily have to include an IC tag RW 31 (FIG. 4), but includes an IC tag reader 31a, instead.

Moreover, the mobile phone device 1a need not acquire the shop ID from the shop terminal 3a, and thus does not have to include the shop ID receiver 113 (FIG. 4). The mobile phone device 1a need not acquire or display shop information, and thus does not have to include the shop information acquisition and display unit 123 (FIG. 4). Accordingly, the load on the hardware of the mobile phone device 1a can reduced.

In this configuration, when a user holds his/her mobile phone device 1a in the vicinity of a position on the shop terminal 3a where the IC tag reader 31a is installed, the shop terminal 3a acquires a tag ID, i.e., a user ID, from the mobile phone device 1a, and attaches a shop ID of the shop to the acquired user ID to transmit the same to the information management server 2a. The information management server 2a receives the transmitted user ID and shop ID, and performs the following process steps in the shop information distribution unit 213a.

That is, the information management server 2a consults the user information storage unit 223 based upon the received user ID to check whether the user is a registered user and whether the user fulfills the age condition of the content to be distributed. If it is determined that the user is a registered user and fulfills the age condition, the information management server 2a consults the shop information storage unit 224 based upon the shop ID to retrieve predetermined shop information, and transmits the retrieved shop information to the shop terminal 3a.

The shop terminal 3a receives, at the shop information display unit 313 thereof, the shop information transmitted from the information management server 2a, and shows the received shop information on a display unit (not shown). On the other hand, if it is determined that the user is not a registered user or fails to fulfill the age condition, the shop terminal 3a displays a warning message to that effect, or the like.

### Third Embodiment

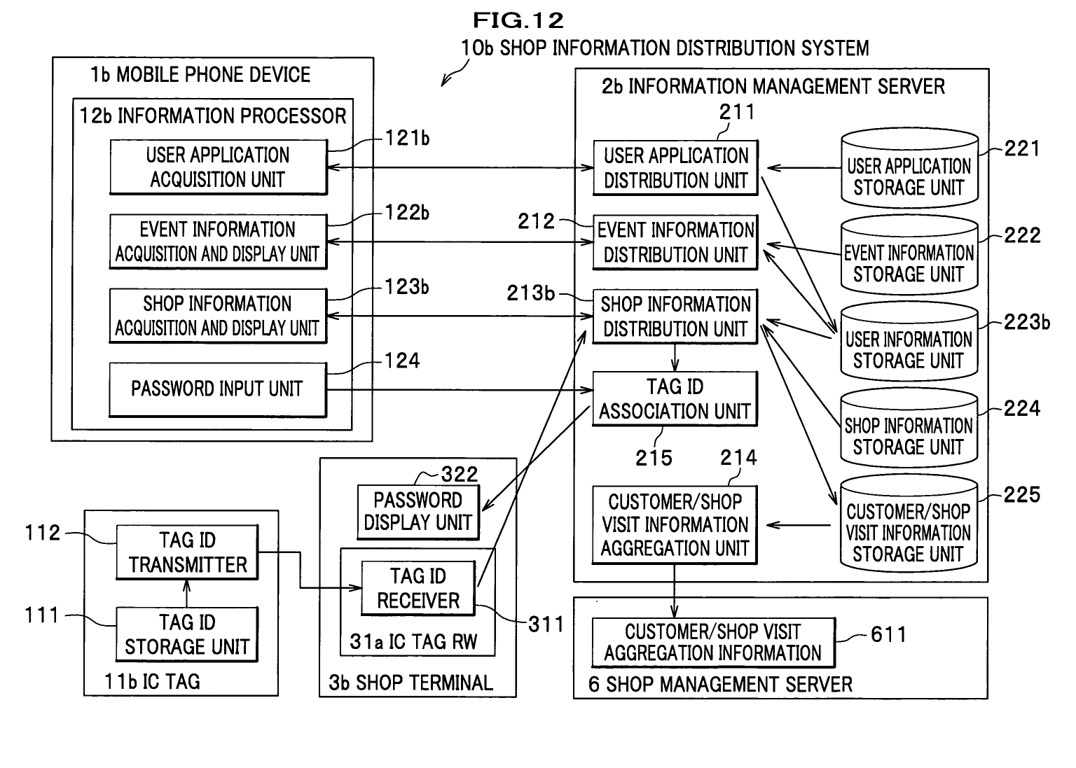

FIG. 12 is a diagram showing an example of functional block configuration of the shop information distribution system according to a third embodiment of the present invention.

The shop information distribution system 10b according to the third embodiment and the shop information distribution system 10 (see FIG. 4) according to the first embodiment are substantially the same in their principal functions and general configurations, and only partially different from each other in detailed functions and configurations. Herein, the same components are designated by the same reference numerals, and a duplicate description thereof will be omitted, whereas the configuration and functions of only the different portion will be described.

In this embodiment, the mobile phone device 1b does not have an IC tag 11b incorporated therein, and thus one which is incorporated in an IC card such as FeliCa® is used for the IC tag 11b. In this instance, the IC tag 11b includes a tag ID storage unit 111 and a tag ID transmitter 112, and the shop terminal 3b includes an IC tag reader 31a having a tag ID receiver 311, and a password display unit 322.

In this embodiment, the information processor 12b of the mobile phone device 1b cannot acquire a tag ID of the IC tag 11b. Therefore, the mobile phone device 1b transmits identifying information assigned to the mobile phone device 1b, as user ID, to the information management server 2b, when the mobile phone device 1b performs the process in the user application acquisition unit 121b, the event information acquisition and display unit 122b, and the shop information acquisition and display unit 123b. On the other hand, the mobile phone device 1b receives through the shop terminal 3b a tag ID of the IC tag 11b as information by which a user is identifiable. Therefore, the user ID (identifying information of the mobile phone device 1b) and the tag ID should be associated (linked) with each other.

The associated information is accumulated in the user information storage unit 223b of the information management server 2b. Thus, the user information includes the USER ID, CONTENT ID, AGE and USER ATTRIBUTE INFORMATION as shown in FIG. 5, plus TAG ID.

In order to associate the user ID (identifying information of mobile phone device 1b) and the tag ID with each other, in the present embodiment, the mobile phone device 1b includes a tag ID association unit 215, the shop terminal 3b includes a password display unit 322, and the mobile phone device 1b includes a password input unit 124.

In the configuration as described above, when the user downloads a user application through the mobile phone device 1b, the information management server 2b, in the process of the user application distribution unit 211 thereof, creates user information and accumulates the created user information in the user information storage unit 223b. However, the TAG ID field of this user information is left blank.

On the other hand, when the user visits the shop, and holds his/her IC card over the shop terminal 3b near a position where the IC tag reader 31a is provided, the tag ID is transmitted from the IC tag 11b incorporated in the IC card, through the shop terminal 3b to the information management server 2b. In this process, the information management server 2b consults the user information storage unit 223b, and if no user information is found therein for the tag ID, executes the tag ID association unit 215, for example to thereby generate a random number having a predetermined number of digits, and transmits the random number as a password to the shop terminal 3b. The shop terminal 3b receives the password and the password display unit 322 thereof shows the password on the display unit (not shown).

The user sees the shown password, and keys the password into the information processor 12b of the mobile phone device 1b through the key button input unit 15 or the like. The password input unit 124 of the mobile phone device 1b receives the inputted password, and transmits to the information management server 2b a set of information which includes the received password and the identifying information assigned to the mobile phone device 1b, i.e., user ID. The tag ID association unit 215 of the information management server 2b receives the set of information which includes the password and the user ID, and confirms that the passwords match with each other, and associates the tag ID transmitted from the IC tag 11b with the user ID, and accumulates the association information in the user information storage unit 223b.

When the tag ID is associated with the user ID as described above, the user may receive event information and shop information distributed in accordance with the contents the user wishes to receive, in substantially the same manner as in the first embodiment. In this embodiment, even an old-fashioned mobile phone device 1b having no IC tag 1b incorporated therein can receive the same services as a later mobile phone device 1 having an IC tag 11b incorporated therein can.

According to the exemplary embodiments, the following advantageous effects may be achieved. The information management server distributes event information of a shop upon receipt of a request for distribution from a portable information terminal which a user carries. Therefore, the event information of the shop is not indiscriminately distributed, but exclusively to the user who wishes to receive the shop information. The information management server distributes shop information concerning merchandise and equipment of a shop to a user when the user visits the shop and causes data communication to take place between the portable information terminal and a shop terminal of the shop. Accordingly, the user has to visit the shop to acquire detailed information on the shop, and thus it is expected that the distribution of the event information of the shop can advantageously produce the effect to draw customers. The information management server can collect customer/shop visit data of the user, and thus can confirm the effectiveness of distribution of the event information of the shop.

Since advertising information is distributed to a user who wishes to receive shop information, it is possible to draw customers to the shop effectively. Moreover, specific advertising information unique to the shop may be distributed in response to a user who visits the shop. Furthermore, the effectiveness of the distributed advertising information for drawing customers can be acquired.

What is claimed is:

1. A shop information distribution method, to be implemented in a shop information distribution system comprising an information management server, a portable information terminal, an IC tag and a shop terminal, wherein the information management server comprises an event information storage unit configured to store event information for at least one shop including a shop in which the shop terminal is installed and a shop information storage unit configured to store shop information on merchandise and equipment of the at least one shop, the portable information terminal is configured to communicate with the information management server and comprises an information processing computer and a display unit, the IC tag is configured to store tag identifying information by which each IC tag is identifiable, and the shop terminal is configured to communicate with the IC tag and the information management server, the shop information distribution method comprising:
the portable information terminal sending a request for relevant event information to the information management server;
the information management server, upon receipt of the request for relevant event information from the portable information terminal, retrieving corresponding event information from the event information storage unit and distributing the retrieved event information to the portable information terminal;
the portable information terminal receiving the distributed event information from the information management server, and showing the received event information on the display unit;
the portable information terminal retrieving, from the shop terminal via the IC tag, shop identifying information by which the shop with the shop terminal installed therein is identifiable, and sending a request for relevant shop information of the shop identified by the retrieved shop identifying information, to the information management server;
the information management server, upon receipt of the request for relevant shop information, retrieving corresponding shop information from the shop information storage unit and distributing the retrieved shop information to the portable information terminal; and
the portable information terminal receiving the distributed shop information from the information management server, and showing the received shop information on the display unit.

2. The shop information distribution method according to claim 1, further comprising:
the portable information terminal receiving a predetermined information retrieving program which is distributed from the information management server and to be executed by the information processing computer for requesting and receiving, through communication with the information management server, information to be shown on the display unit.

3. The shop information distribution method according to claim 1, wherein the information management server further comprises a customer/shop visit information storage unit configured to store information on customers visiting the at least one shop, the shop information distribution method further comprising:
the information management server, upon receipt of the request for relevant shop information, creating information on a visit of a customer by associating the shop identifying information attached to the received request for relevant shop information, portable information terminal identifying information on the portable information terminal from which the request for relevant shop information has been sent, and date/time information on the date and time of the receipt of the request for relevant shop information, and storing the created information in the customer/shop visit information storage unit; and
the information management server aggregating, at predetermined intervals, the numbers of visits of each of the customers to the at least one shop, based upon the information stored in the customer/shop visit information storage unit for a period corresponding to each interval.

4. A shop information distribution method, to be implemented in a shop information distribution system comprising an information management server, a portable information terminal, an IC tag and a shop terminal, wherein the information management server comprises an event information storage unit configured to store event information for at least one shop including a shop in which the shop terminal is installed and a shop information storage unit configured to store shop information on merchandise and equipment of the at least one shop, the portable information terminal is configured to communicate with the information management server and comprises an information processing computer and a display unit, the IC tag is configured to store tag identifying information by which each IC tag is identifiable, and the shop terminal is configured to communicate with the IC tag and the information management server, the shop information distribution method comprising:
the portable information terminal sending a request for relevant event information to the information management server;
the information management server, upon receipt of the request for relevant event information from the portable information terminal, retrieving corresponding event information from the event information storage unit and distributing the retrieved event information to the portable information terminal;
the portable information terminal receiving the distributed event information from the information management server, and showing the received event information on the display unit;
the shop terminal receiving the tag identifying information sent from the IC tag, and sending the received tag identifying information to the information management server;
the information management server, upon receipt of the tag identifying information sent from the shop terminal, retrieving from the shop information storage unit corresponding shop information of the shop in which the shop terminal which has sent the tag identifying information is installed, and distributing the retrieved shop information to the portable information terminal specified by the tag identifying information; and
the portable information terminal receiving the distributed shop information from the information management server, and showing the received shop information on the display unit.

5. The shop information distribution method according to claim 4, further comprising:
the portable information terminal receiving a predetermined information retrieving program which is distributed from the information management server and to be executed by the information processing computer for requesting and receiving, through communication with the information management server, information to be shown on the display unit.

6. The shop information distribution method according to claim 4, wherein the information management server further comprises a customer/shop visit information storage unit configured to store information on customers visiting the at least one shop, the shop information distribution method further comprising:
the information management server, upon receipt of the tag identifying information sent from the shop terminal, creating information on a visit of a customer by associating the received tag identifying information, corresponding shop identifying information of the shop in which is installed the shop terminal which has received the tag identifying information from the IC tag and sent the received tag identifying information to the information management server, and date/time information on the date and time of the receipt of the tag identifying information, and storing the created information in the customer/shop visit information storage unit; and
the information management server aggregating, at predetermined intervals, the numbers of visits of each of the customers to the at least one shop, based upon the information stored in the customer/shop visit information storage unit for a period corresponding to each interval.

7. A shop information distribution system comprising an information management server, a portable information terminal, an IC tag and a shop terminal, the information management server comprising an event information storage unit configured to store event information for at least one shop including a shop in which the shop terminal is installed and a shop information storage unit configured to store shop information on merchandise and equipment of the at least one shop, the portable information terminal configured to communicate with the information management server and comprising an information processing computer and a display unit, the IC tag configured to store tag identifying information by which each IC tag is identifiable, and the shop terminal configured to communicate with the IC tag and the information management server, wherein
the portable information terminal is configured to send a request for relevant event information to the information management server;
the information management server is configured to, upon receipt of the request for relevant event information from the portable information terminal, retrieve corresponding event information from the event information storage unit and distribute the retrieved event information to the portable information terminal;
the portable information terminal is configured to receive the distributed event information from the information management server, and show the received event information on the display unit;
the portable information terminal is configured to retrieve, from the shop terminal via the IC tag, shop identifying information by which the shop with the shop terminal installed therein is identifiable, and send a request for relevant shop information of the shop identified by the retrieved shop identifying information, to the information management server;
the information management server is configured to, upon receipt of the request for relevant shop information, retrieve corresponding shop information from the shop information storage unit and distribute the retrieved shop information to the portable information terminal; and
the portable information terminal is configured to receive the distributed shop information from the information management server, and show the received shop information on the display unit.

8. The shop information distribution system according to claim 7, wherein the portable information terminal is further configured to receive a predetermined information retrieving program which is distributed from the information management server and to be executed by the information processing computer for requesting and receiving, through communication with the information management server, information to be shown on the display unit.

9. The shop information distribution system according to claim 7, wherein the information management server further comprises a customer/shop visit information storage unit configured to store information on customers visiting the at least one shop,
the information management server is configured to, upon receipt of the request for relevant shop information, create information on a visit of a customer by associating the shop identifying information attached to the received request for relevant shop information, portable information terminal identifying information on the portable information terminal from which the request for relevant shop information has been sent, and date/time information on the date and time of the receipt of the request for relevant shop information, and store the created information in the customer/shop visit information storage unit; and
the information management server is configured to aggregate, at predetermined intervals, the numbers of visits of each of the customers to the at least one shop, based upon the information stored in the customer/shop visit information storage unit for a period corresponding to each interval.

10. The shop information distribution system according to claim 7, wherein the portable information terminal incorporates the IC tag inside, and is configured to access information stored in the IC tag.

11. A shop information distribution system comprising an information management server, a portable information terminal, an IC tag and a shop terminal, wherein the information management server comprises an event information storage unit configured to store event information for at least one shop including a shop in which the shop terminal is installed and a shop information storage unit configured to store shop information on merchandise and equipment of the at least one shop, the portable information terminal is configured to communicate with the information management server and comprises an information processing computer and a display unit, the IC tag is configured to store tag identifying information by which each IC tag is identifiable, and the shop terminal is configured to communicate with the IC tag and the information management server,
the portable information terminal is configured to send a request for relevant event information to the information management server;
the information management server is configured to, upon receipt of the request for relevant event information from the portable information terminal, retrieve corresponding event information from the event information storage unit and distribute the retrieved event information to the portable information terminal;
the portable information terminal is configured to receive the distributed event information from the information management server, and show the received event information on the display unit;
the shop terminal is configured to receive the tag identifying information sent from the IC tag, and send the received tag identifying information to the information management server;
the information management server is configured to, upon receipt of the tag identifying information sent from the shop terminal, retrieve from the shop information storage unit corresponding shop information of the shop in which the shop terminal which has sent the tag identifying information is installed, and distribute the retrieved shop information to the portable information terminal specified by the tag identifying information; and
the portable information terminal is configured to receive the distributed shop information from the information management server, and show the received shop information on the display unit.

12. The shop information distribution system according to claim 11, wherein the portable information terminal is further configured to receive a predetermined information retrieving program which is distributed from the information management server and to be executed by the information processing computer for requesting and receiving, through communication with the information management server, information to be shown on the display unit.

13. The shop information distribution system according to claim 11, wherein the information management server further comprises a customer/shop visit information storage unit configured to store information on customers visiting the at least one shop,
the information management server is configured to, upon receipt of the tag identifying information sent from the shop terminal, create information on a visit of a customer by associating the received tag identifying information, corresponding shop identifying information of the shop in which is installed the shop terminal having received the tag identifying information from the IC tag and sent the received tag identifying information to the information managing server, and date/time information on the date and time of the receipt of the tag identifying information, and store the created information in the customer/shop visit information storage unit; and
the information management server is configured to aggregate, at predetermined intervals, the numbers of visits of each of the customers to the at least one shop, based upon the information stored in the customer/shop visit information storage unit for a period corresponding to each interval.

14. An information management server for use in a shop information distribution system comprising, in addition to the information management server, a portable information terminal, an IC tag and a shop terminal, wherein the portable information terminal is configured to communicate with the information management server and comprises an information processing computer and a display unit, the IC tag is configured to store tag identifying information by which each IC tag is identifiable, and the shop terminal is configured to communicate with the IC tag and, the information management server, and wherein the information management server comprises:
an event information storage unit configured to store event information for at least one shop including a shop in which the shop terminal is installed;
a shop information storage unit configured to store shop information on merchandise and equipment of the at least one shop;
means for receiving a request for relevant event information from the portable information terminal, retrieving corresponding event information from the event information storage unit and distributing the retrieved event information to the portable information terminal; and
means for receiving a request for relevant shop information from the portable information terminal, retrieving corresponding shop information specified by shop identifying information from the shop information storage unit and distributing the retrieved shop information to the portable information terminal.

15. The information management server according to claim 14 further comprising
means for distributing a predetermined information retrieving program to the portable information terminal in response to a request for distribution of the information retrieving program sent from the portable information terminal.

16. The information management server according to claim 14 further comprising:
a customer/shop visit information storage unit configured to store information on customers visiting the at least one shop;
means for creating, upon receipt of the request for relevant shop information, information on a visit of a customer by associating the shop identifying information attached to the received request for relevant shop information, portable information terminal identifying information on the portable information terminal from which the request for relevant shop information has been sent, and date/time information on the date and time of the receipt of the request for relevant shop information, and storing the created information in the customer/shop visit information storage unit; and
means for aggregating, at predetermined intervals, the numbers of visits of each of the customers to the at least one shop, based upon the information stored in the customer/shop visit information storage unit for a period corresponding to each interval.

17. An information management server for use in a shop information distribution system comprising, in addition to the information management server, a portable information terminal, an IC tag and a shop terminal, wherein the portable information terminal is configured to communicate with the information management server and comprises an information processing computer and a display unit, the IC tag is configured to store tag identifying information by which each IC tag is identifiable, and the shop terminal is configured to communicate with the IC tag and the information management server, and wherein the information management server comprises:
an event information storage unit configured to store event information for at least one shop including a shop in which the shop terminal is installed;
a shop information storage unit configured to store shop information on merchandise and equipment of the at least one shop;
means for receiving a request for relevant event information from the portable information terminal, retrieving corresponding event information from the event information storage unit and distributing the retrieved event information to the portable information terminal; and
means for receiving tag identifying information sent from the IC tag through the shop terminal, retrieving from the shop information storage unit shop information of the shop in which the shop terminal which has sent the tag identifying information is installed, and distributing the retrieved shop information to the portable information terminal specified by the tag identifying information.

18. The information management server according to claim 17 further comprising
means for distributing a predetermined information retrieving program to the portable information terminal in response to a request for distribution of the information retrieving program sent from the portable information terminal.

19. The information management server according to claim 17 further comprising:
a customer/shop visit information storage unit configured to store information on customers visiting the at least one shop;
means for creating, upon receipt of the tag identifying information sent from the shop terminal, information on a visit of a customer by associating the received tag identifying information, corresponding shop identifying information of the shop in which is installed the shop terminal which has received the tag identifying information from the IC tag and sent the received tag identifying information to the information management server, and date/time information on the date and time of the receipt of the tag identifying information, and storing the created information in the customer/shop visit information storage unit; and
means for aggregating, at predetermined intervals, the numbers of visits of each of the customers to the at least one shop, based upon the information stored in the customer/shop visit information storage unit for a period corresponding to each interval.

20. A portable information terminal for use in a shop information distribution system comprising, in addition to the portable information terminal, an information management server, an IC tag and a shop terminal, wherein the information management server comprises an event information storage unit configured to store event information for at least one shop including a shop in which the shop terminal is installed and a shop information storage unit configured to store shop information on merchandise and equipment of the at least one shop, the IC tag is configured to store tag identifying information by which each IC tag is identifiable, and the shop terminal is configured to communicate with the IC tag and the information management server, wherein the portable information terminal comprises:
an information processing computer;
a display unit;
means for communicating with the information management server;
means for sending a request for relevant event information to the information management server;
means for receiving the event information distributed from the information management server, and showing the received event information on the display unit;
means for retrieving, from the shop terminal via the IC tag, shop identifying information by which is identifiable the shop in which the shop terminal is installed, and sending a request for relevant shop information of the shop identified by the retrieved shop identifying information, to the information management server; and
means for receiving the shop information distributed from the information management server, and showing the received shop information on the display unit.

21. The portable information terminal according to claim 20 further comprising means for receiving a predetermined information retrieving program which is distributed from the information management server and to be executed by the information processing computer for requesting and receiving, through means for communicating with the information management server, information to be shown on the display unit.

22. The portable information terminal according to claim 20 which incorporates the IC tag inside, and further comprises means for accessing information stored in the IC tag.

23. A portable information terminal for use in a shop information distribution system comprising, in addition to the portable information terminal, an information management server, an IC tag and a shop terminal, wherein the information management server comprises an event information storage unit configured to store event information for at least one shop including a shop in which the shop terminal is installed and a shop information storage unit configured to store shop information on merchandise and equipment of the at least one shop, the IC tag is configured to store tag identifying information by which each IC tag is identifiable, and the shop terminal is configured to communicate with the IC tag and the information management server, wherein the portable information terminal comprises:
an information processing computer;
a display unit;
means for communicating with the information management server;
means for sending a request for relevant event information to the information management server;
means for receiving the event information distributed from the information management server, and showing the received event information on the display unit; and
means for receiving the shop information distributed from the information management server, and showing the received shop information on the display unit.

24. The portable information terminal according to claim 23 further comprising means for receiving a predetermined information retrieving program which is distributed from the information management server and to be executed by the information processing computer for requesting and receiving, through means for communicating with the information management server, information to be shown on the display unit.
